(19) United States
(12) Patent Application Publication
(10) Pub. No.: US 2013/0203536 A1
(43) Pub. Date: Aug. 8, 2013

(54) Integral Support And Build Fixture For A Wing Pulley And Associated Methods

(71) Applicants: Guy Mulee, Laurinburg, NC (US); Weldon Seals, Bennettsville, SC (US)

(72) Inventors: Guy Mulee, Laurinburg, NC (US); Weldon Seals, Bennettsville, SC (US)

(73) Assignee: Baldor Electric Company, Fort Smith, AR (US)

(21) Appl. No.: 13/368,594

(22) Filed: Feb. 8, 2012

(51) Int. Cl. F16H 55/36; B21K 1/42

(52) U.S. Cl. 474/185; 29/892.1

(57) ABSTRACT

A wing pulley has a support that acts as a fixture to assist in locating the wings of the wing pulley and the spacers of the wing pulley during manufacture of the pulley. Methods of constructing the wing pulley are also disclosed.

### BACKGROUND

The disclosure relates to a wing pulley having an integral support and build fixture for supporting and locating the wings and the spacers of the wing pulley.

### BRIEF DESCRIPTION OF THE DRAWINGS

FIG. 1A shows an exploded perspective view of a wing pulley as described herein;

FIG. 1B shows an exploded perspective view of an alternate embodiment of the wing pulley of FIG. 1A;

FIG. 2 shows a perspective view of the wing pulley of FIG. 1A with a wing removed and adjacent spacers removed to show the relative construction of the wing pulley;

FIG. 3 shows a front elevational view of a hub of the wing pulley of FIG. 1A;

FIG. 4 shows a side view of the hub of FIG. 3;

FIG. 5 shows a front elevational view of a support of the wing pulley of FIG. 1A;

FIG. 6 shows a side view of the support of FIG. 5; and

FIG. 7 is view of the pulley of FIG. 1A from an axial end with three wings positioned in slots of the support and a spacer positioned between adjacent wings with a portion of the hub shown in section to illustrate the cooperative relationship of the aforementioned elements.

### DETAILED DESCRIPTION

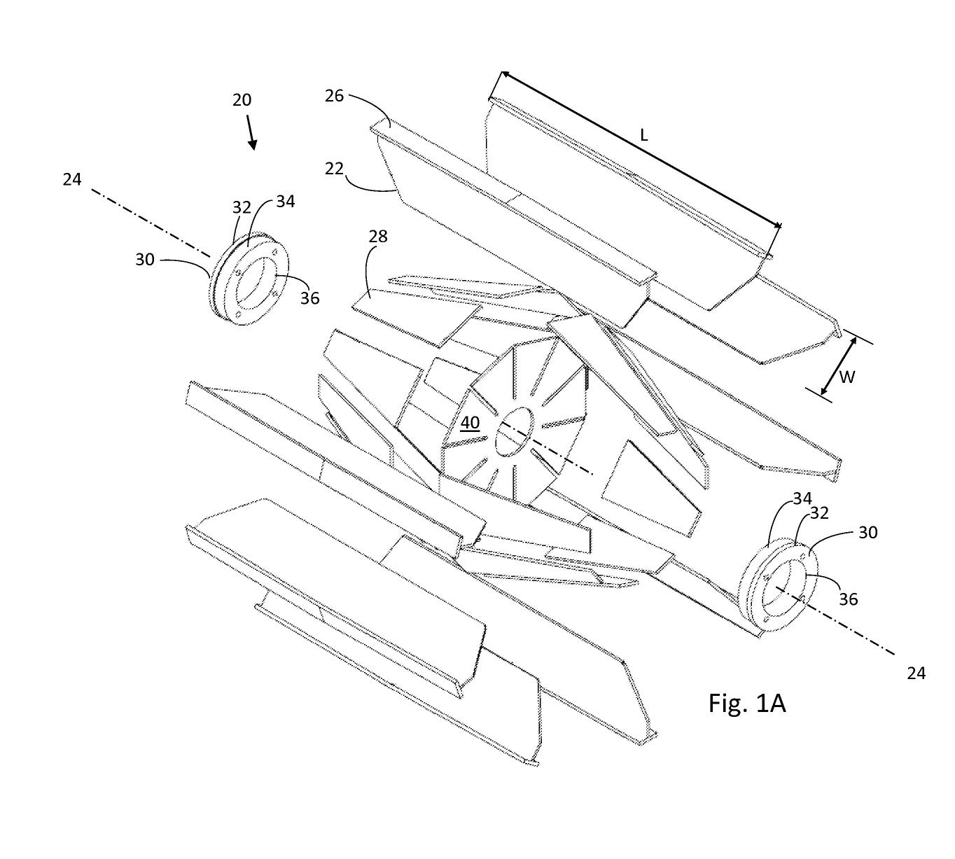

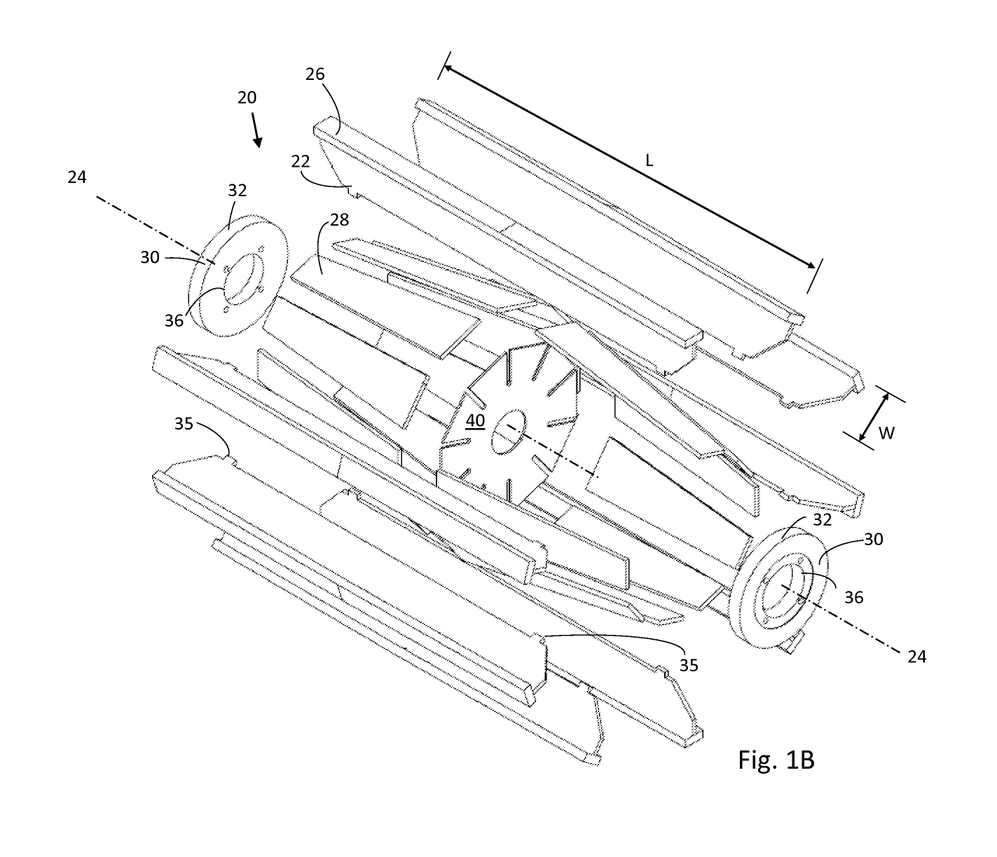

Referring to FIGS. 1A and 1B, the wing pulley 20 comprises a plurality of wings 22 extending radially outward from an axis of rotation 24 of the pulley. The axis of rotation 24 of the pulley may coincide with a longitudinal center line or center axis of the pulley. The wings 22 may be equiangularly spaced about the center axis of the pulley. Although the drawings show an embodiment of the pulley with 10 wings, other configurations may be used. The wings may extend in length to define a longitudinal length L (FIG. 1A,1B) of the wing pulley. Each of the wings has a width W (FIG. 1A,1B) that as described below in part defines a diameter of the wing pulley. One or more wings may have belt engagement surfaces 26 along a distal edge of the wing width W. As shown in the drawings, the belt engagement surfaces 26 are transverse to the wing width distal edge and extend along the length L of the wing. Although the drawings show an embodiment of the pulley with generally flat belt engagement surfaces, other configurations may be used. For instance, the belt engagement surfaces may be rounded or crowned. Belt engagement surface may also be omitted. The wing pulley comprises spacers 28 disposed between the wings 22 of the pulleys. The spacers 28 may be tapered toward longitudinal ends of the pulley.

The pulley may be provided with a hub 30 adjacent to each longitudinal end of the pulley. As shown in the drawings, the longitudinal length of the wings 22 may be longer than the axial distance between the hubs such that a portion of the length L of the wing extends axially beyond the hubs 30. As shown in FIG. 1A, the hubs 30 have an outer diameter 32 and a locating diameter 34 which is smaller than the outer diameter, and the locating diameter 34 supports each of the wings 22 on a proximal width edge of the wing. The locating diameter 34 may also support the spacers 28. FIG. 1B shows an alternate embodiment of the wing pulley of FIG. 1A where the hubs 30 have an outer diameter 32 that supports the wings 22, and the locator diameter (i.e., “34” of FIG. 1A) has been omitted. In the pulley of FIG. 1B, the wings 22 have their proximal width edges formed with a tab 35 to assist in assembling the pulley as described below in greater detail. The wings and the hubs may also be formed with other features that cooperate with each other to assist in locating the wing on the hub and setting the axial spacing the hub relative to the wing. The hubs 30 may have a center opening 36 to accommodate a shaft of the pulley.

The wing pulley may be provided with an internal support 40 comprising a planar member with an outer periphery 42. As shown in the drawings, the outer periphery 42 comprises flats extending around the periphery to define a polygonal-shape for the support. The support 40 may have a center axis and may have a center hole 44 aligned with center axis to accommodate a shaft (not shown) of the pulley. The center hole may also be omitted. The support 40 may have a plurality of slots 46 extending radially outward in a direction that intersects with a center axis of the support. When assembled to form the pulley, the support axis (and center hole 44) and pulley center axis 24 may be aligned. The slots 46 may have a slot bottom 48. The slot bottoms 48 may be arranged at a distance from the support center hole 44 and spaced from the pulley center axis 24. The support may be provided in a longitudinal center of the pulley as shown in the drawings. With the support in the longitudinal center of the pulley, the spacers may all have the same shape. The support may also be provided in a different position relative to the longitudinal center, and accordingly, the spacers extending toward one hub would be shaped differently from the spacers extending toward the axially opposite hub.

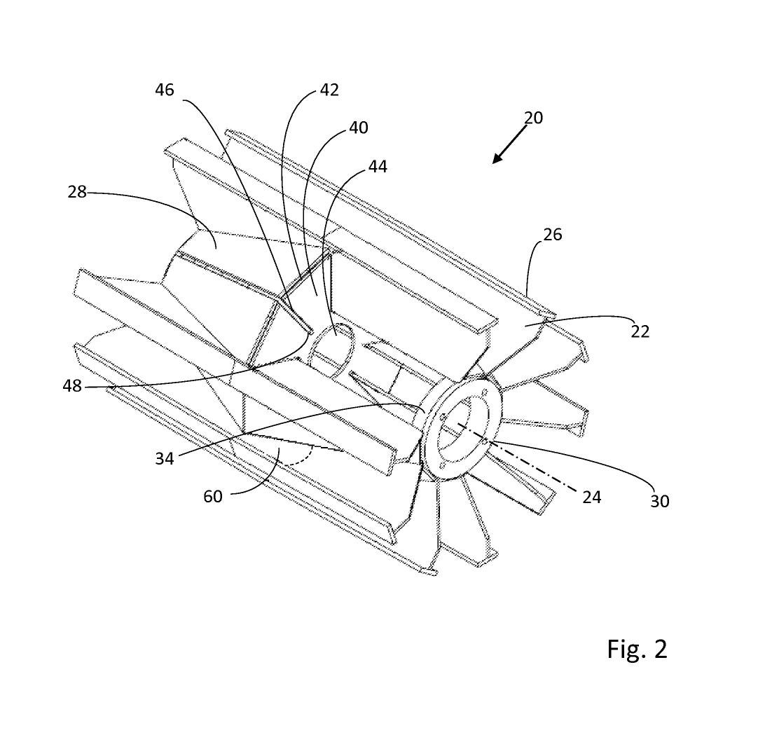

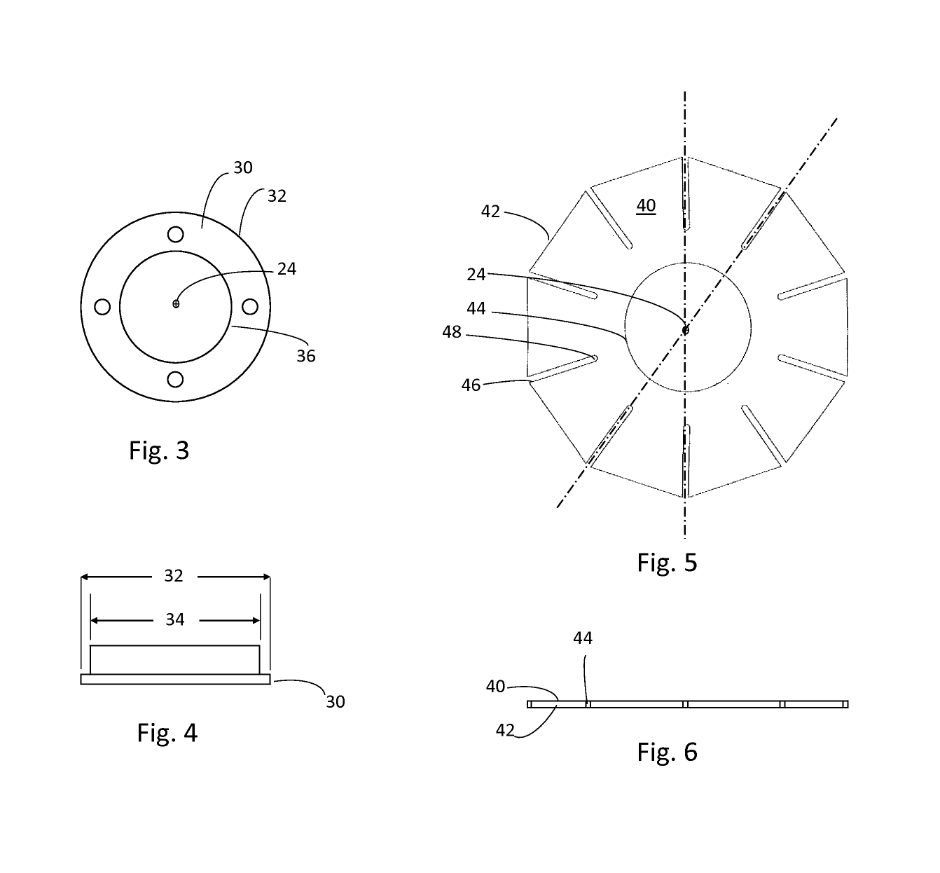

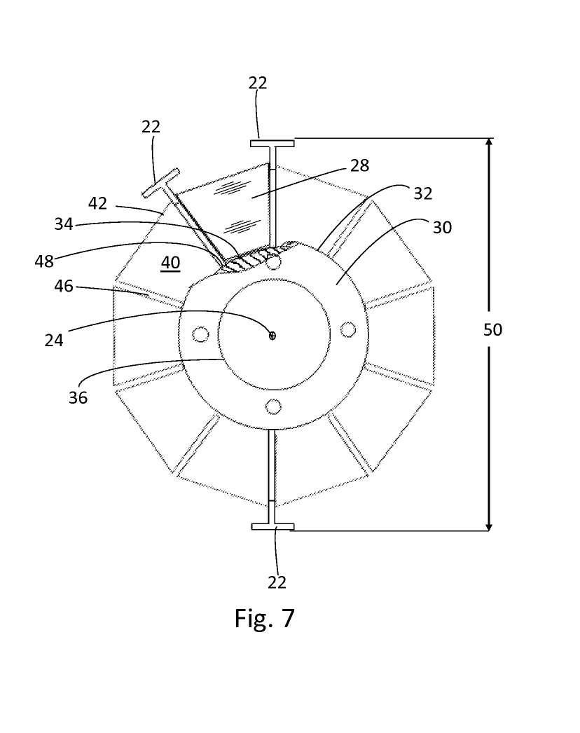

The slots 46 of the support 40 may be formed to accommodate the wings 22 of the pulley. Although not shown in the drawings, the cooperative features of the support and wings may be reversed and the wings may also be formed with slots to accommodate the support, or a combination thereof. The wings and support, for instance, the wing width proximal edge and support slots, may be formed with features that cooperate with each other and locate the support relative to the wings along a longitudinal length of the wing. With the slots 46 of the support 40 arranged to intersect the support center hole 44 (and thus the center axis 24 of the pulley upon assembly), the wings 22 are preferably radially aligned with (i.e., perpendicular to) the center axis of the pulley to provide an optimal force distribution for the wing. The slots 46 may have width dimensions sized in accordance with a thickness of the wings 22 to form a snug fit or press fit between the wings and the slots. The wing width W, together with the relative position of the slot bottoms 48, defines a diameter 50 for the wing pulley (FIG. 7). The outer periphery 42 of the support 40 supports the spacers 28. The outer periphery 42 of the support 40 and the hubs 30 (for instance, the locator diameter 34) may be dimensioned to provide the spacers with a desired taper angle 60 (FIG. 2) relative to the axis of rotation of the pulley. The spacers 28 may be shaped and sized to provide a snug fit between the wings 22 after the wings are fitted in the slots 46 of the support 40 during assembly of the pulley.

The support 40 as described herein provides an internal support and build fixture to facilitate assembly of the wing pulley during manufacture. Thus, the support in effect provides a locator for the wings. Once the wings are installed, the wings and the support, provide a locator for the spacers. In accordance with one exemplary method of manufacturing the pulley, for instance, the support 40 may function as a build fixture to enable manufacturing the pulley with the wings 22 aligned with the center axis 24 of the pulley. An arbor (note shown) may be extended through the opening 36 in each hub 30 and the support center hole 44 along the pulley center axis 24 and used to set the initial axial spacing of the support and hubs along the longitudinal length of the pulley. In the pulley of FIG. 1A, the axial spacing between the hubs may be set by the wing length along the proximal width edge of the wing abutting a shoulder of the hub formed between the outer diameter 32 and the locator diameter 34. In the pulley of FIG. 1B, the axial spacing between the hubs 30 may be set by the wing tabs 35 along the proximal width edge that may be abutted against an inner face of (i.e., behind) the respective hub with the wing proximal width edge seated on the hub outer diameter 32. With the support 40 in position relative to the hubs 30 along the longitudinal length of the pulley, the wings 22 may be seated in their respective slots 46 of the support. The support 40 acts as a fixture to provide the locators for the wings 22. In the pulley of FIG. 1A, longitudinal ends of the wings may be located on the hub locator diameter 34. In the pulley of FIG. 1B, longitudinal ends of the wings may be located on the hub outer diameter 32. In each case, the hub supports each wing. The spacers 28 may then be seated between the wings against the outer periphery 42 of the support 40 and the respective hub 30. For instance, in the pulley of FIG. 1A, the spacers 28 may be supported on the locator diameter 34 of the hub, and in the pulley of FIG. 1B, the spacers 28 may be supported on the outer diameter 34 of the hub. With the spacers 28 fitted to the outer periphery 42 of the support 40 and each respective hub (i.e., the locator diameter 34 (FIG. 1A) or outer diameter 32 (FIG. 1B)), a desired taper angle 60 and a consistent diameter of the spacers is set. The spacers may then be welded to the wings, the support, and the hubs to form an integral pulley. The arbor may then be removed.

The support acts as a stiffener for the wing pulley that prevents wing collapse. The support also provides a build fixture to allow assembly of the wing pulley ensuring that the wings are held perpendicular to the axis of rotation of the pulley, thereby reducing the possibility of wing folding failure. The support also helps locate the spacers at a consistent diameter around the pulley.

In view of the foregoing, it will be seen that several advantages are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. The breadth and scope of the present invention should not be limited by any of the above-described exemplary embodiments, but should be defined only in accordance with the following claims appended hereto and their equivalents.

What is claimed is:

1. A wing pulley having a center axis extending along a longitudinal length of the pulley, the pulley having a first hub adjacent to a longitudinal end of the pulley and a second hub adjacent to an axially opposite longitudinal end of the pulley, the pulley having a support between the first and second hubs, the support having a plurality of slots extending radially outward in a direction that intersects with the pulley center axis, the support slots each having a slot bottom, the support slots receiving a plurality of wings for the pulley, the wings having a length parallel to the pulley centerline and a width transverse to the length, the wings seated in the slots against the slot bottoms and extending radially outward from the slots, the support slot bottoms being spaced from the center axis and together with the wing widths providing the pulley with a desired diameter, the support having an outer periphery, the support outer periphery and the first and second hubs supporting a plurality of spacers between the wings, the support and the first and second hubs being sized to provide the pulley with a desired taper angle along the spacers relative to the pulley center axis.

2. The wing pulley of claim 1 wherein the wings and the slots are sized to provide a snug fit between the wings and the slots.

3. The wing pulley of claim 1 wherein the wings and the spacers are sized to provide a snug fit between the spacers and the wings.

4. The wing pulley of claim 1 wherein the wings have belt engagement surfaces generally transverse to the wings extending along the length of the wing.

5. The wing pulley of claim 1 wherein the spacers and the wings are welded together.

6. The wing pulley of claim 1 wherein the spacers and the supports are welded together.

7. The wing pulley of claim 1 wherein the wings are supported by the hubs.

8. The wing pulley of claim 1 wherein the support is intermediate the first and second hubs in a longitudinal center of the pulley.

9. The wing pulley of claim 1 wherein the support has a center opening sized to accommodate a shaft for the pulley.

10. The wing pulley of claim 1 wherein the support outer periphery is polygonally shaped.

11. A method of constructing a wing pulley comprising:
providing a fixture for assembling the wing pulley wherein the fixture comprises a planar member with an outer periphery with a plurality of slots extending radially outward in a direction that intersects with a center axis of the fixture, each of the slots having a slot bottom;
providing a first hub aligned with the fixture center axis facing a planar side of the fixture and a second hub aligned with the fixture center axis facing the opposite planar side of the fixture, the hubs having a central opening aligned with the fixture center axis to accommodate a shaft for the pulley;
inserting a wing in each of the slots, each wing having a length parallel to the fixture center line and a width transverse to the length, each wing being inserted in its respective slot such that it extends radially outward from the slot from the slot bottom, the center support slot bottom and together with the wing width forming the wing pulley at a desired diameter; and
inserting a spacer between each of the wings such that the spacer is supported by the outer periphery of the fixture and the respective first and second hubs, the fixture outer periphery and the first and second hubs being sized to provide the wing pulley with a desired taper angle along the spacers relative to the pulley center axis.

12. The method of claim 11 wherein the wings and the slots are sized to provide a snug fit between wings and slots.

13. The method of claim 11 wherein the wings and spacers are sized to provide a snug fit between the spacers and the wings.

14. The method of claim 11 wherein the wings have belt engagement surfaces generally transverse to the wings extending along the length of the wing.

15. The method of claim 11 further comprising welding the spacers and the wings together.

16. The method of claim 11 further comprising welding the spacers and the supports together.

17. The method of claim 11 further wherein the wings are supported by the hubs.

18. The method of claim 11 further comprising arranging each of the hubs from the fixture at generally the same distance.

19. The method of claim 11 wherein the fixture has a center opening sized to accommodate a shaft for the pulley.

20. The method of claim 11 wherein the fixture outer periphery is polygonally shaped.

21. The method claim 11, further comprising using the wings to set an axial spacing of the hubs.

22. A wing pulley having a plurality of wings extending outward in a direction that intersects an axis of rotation of the pulley, the pulley having an internal support between longitudinal ends of the pulley, the internal support supporting the wings of the pulley, the internal support having flats formed around its outer periphery, the flats supporting spacers disposed between the wings, and the spacers extending toward longitudinal ends of the pulley at angle relative to the axis of rotation of the pulley.

23. The wing pulley of claim 22 wherein the internal support has a plurality of slots extending radially outward in a direction that intersects with the axis of rotation of the pulley and the wings are disposed in the slots to provide the pulley with a desired diameter.

24. The wing pulley of claim 22 wherein pulley has first and second hubs aligned with the axis of rotation of the pulley, and the internal support and the first and second hubs are sized to provide the pulley with a desired taper angle along the spacers relative to the axis of rotation of the pulley.

25. The wing pulley of claim 22 wherein the support is in a longitudinal center of the pulley.
